(19) United States
(12) Patent Application Publication
(10) Pub. No.: US 2022/0190672 A1
(43) Pub. Date: Jun. 16, 2022

(54) ROLLING BEARING DEVICE FOR ROTARY ELECTRIC MACHINE

(71) Applicant: VALEO EQUIPEMENTS ELECTRIQUES MOTEUR, Creteil Cedex (FR)

(72) Inventors: Andre SAUVIGNET, Creteil Cedex (FR); Michael CLAIS, Creteil Cedex (FR); Pierre Yves LEURIDAN, Etaples-sur-Mer (FR); Benjamin POUCHELLE, Etaples-sur-Mer (FR); Fabrice TAUVRON, Creteil Cedex (FR)

(73) Assignee: VALEO EQUIPEMENTS ELECTRIQUES MOTEUR, Creteil Cedex (FR)

(21) Appl. No.: 17/644,442

(22) Filed: Dec. 15, 2021

(30) Foreign Application Priority Data
Dec. 15, 2020 (FR) 20 13296

(51) Int. Cl. H02K 5/173; F16C 19/06

(52) U.S. Cl. CPC H02K 5/1735; F16C 2380/26; F16C 19/06

(57) ABSTRACT

A rolling bearing device that can be mounted around a shaft of a rotary electric machine of axis X, and axially above a rotor assembly. The rolling bearing device includes a rolling bearing having an inner race and an outer race that are centred on the axis; a target holder which is fixed to the inner race and extends radially with respect to the axis beyond the outer race, and in a base extended by an axial lip, a target which is secured to the target holder and is able to cooperate with a detection means for tracking the rotation of the race about the axis. The base of the target holder includes at least one axially protruding tab designed to axially deform when the base bears against the rotor assembly once the rolling bearing has been mounted on the shaft.

The invention relates in particular to a rolling bearing device for a rotary electric machine.

The invention is particularly advantageously applicable in the field of rotary electric machines such as alternators, starter-alternators, or even reversible machines or electric motors. It will be recalled that a reversible machine is a rotary electric machine that is able to operate reversibly, both as an electric generator when functioning as an alternator and as an electric motor for example for starting the combustion engine of the vehicle, such as a motor vehicle.

A rotary electric machine comprises a rotor that is able to rotate about an axis, and a stator that is fixed via a rolling bearing device. In alternator mode, when the rotor is rotating, it induces a magnetic field at the stator, which converts it into electric current in order to supply power to the electrical consumers of the vehicle and to recharge the battery. In motor mode, the stator is electrically powered and induces a magnetic field causing the rotor to rotate, for example, in order to start the combustion engine. This rotary electric machine is fitted with means for tracking the angular position of the rotor. These means determine the angular position of the rotor with respect to the wound stator, in order in particular to inject current into the wound stator at the right time when the rotary electric machine is operating in electric motor mode. These tracking means are advantageously partially borne by the rolling bearing device. Given the high rotational speeds of the machine, it is essential to improve the robustness, in particular of the rotating parts of the machine.

To that end, the subject of the present invention is therefore a rolling bearing device that can be mounted around a shaft of a rotary electric machine of axis X, and axially above a rotor assembly, the rolling bearing device comprising: a rolling bearing comprising an inner race and an outer race that are centred on the axis; a target holder which is fixed to the inner race and extends radially with respect to the axis beyond the outer race, in a base extended by an axial lip, a target which is secured to the target holder and is able to cooperate with a detection means for tracking the rotation of the race about the axis, characterized in that the base of the target holder comprises at least one axially protruding tab designed to axially deform when the base bears against the rotor assembly once the rolling bearing has been mounted on the shaft.

The stresses to which the target holder is subjected are in particular absorbed by the tabs, thereby limiting the risk of breakage. This makes the rolling bearing device more robust. The reliability of the measurement performed by the position sensor is improved thereby.

According to one embodiment, the tab extends radially.

According to one embodiment, the base comprises at least one opening through which the tab extends between two ends.

According to one embodiment, the ratio between a maximum circumferential extension of the opening ϕ1 and a maximum circumferential extension of the tab ϕ2 is between 3 and 20.

According to one embodiment, the tab is fixed by its two ends to the rest of the base of the target holder.

According to one embodiment, the tab is fixed at one end to the base of the target holder, the other end being free.

According to one embodiment, the tab is obtained by stamping.

According to one embodiment, the device comprises four tabs distributed evenly about the axis X of the machine.

Another subject of the invention is a rotary electric machine comprising a rotary shaft, a rotor assembly which rotates conjointly with the shaft, a stator surrounding the rotor, and a rolling bearing device in which the at least one tab of the base of the target holder is mounted under stress against the rotor assembly.

According to one embodiment, the rotor assembly comprises a fan, the at least one tab of the base of the target holder being mounted under stress against the fan.

The present invention may be understood better from reading the following detailed description of non-limiting implementation examples of the invention, and from studying the appended drawings.

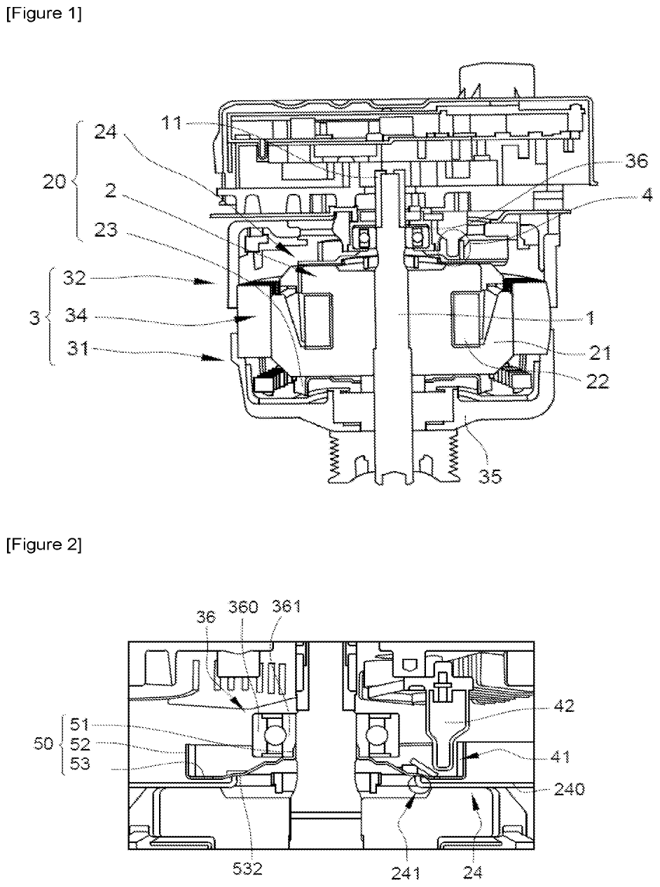

FIG. 1 schematically and partially shows a sectional view of a rotary electric machine according to one example of the invention.

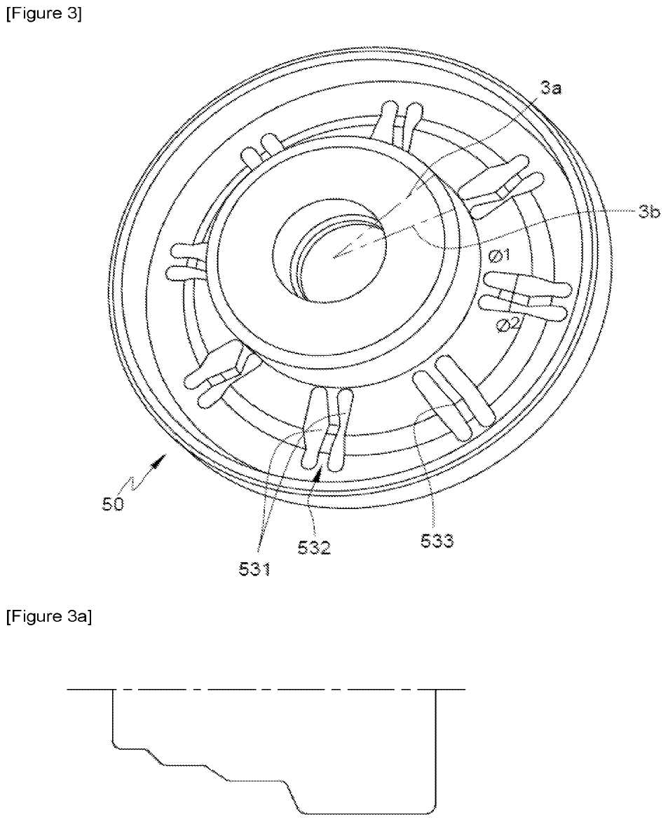

FIG. 2 schematically and partially shows a sectional view of the rolling bearing device.

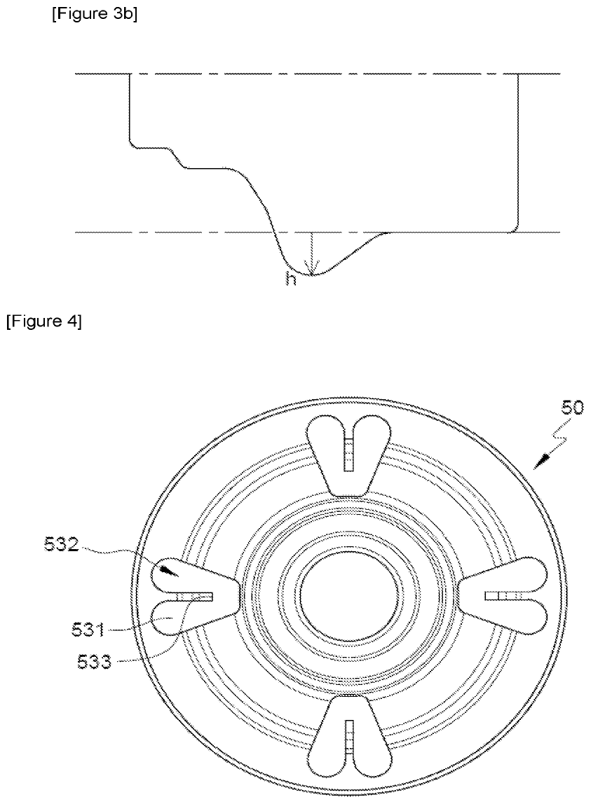

FIG. 3, FIG. 3a and FIG. 3b illustrate the target holder in perspective in a first embodiment, and sectional views of the target holder at the base in the absence of a tab and at the base with a tab, respectively.

FIG. 4 is a view from above of a target holder according to a second embodiment.

Identical, similar or analogous elements retain the same references from one figure to another. It will also be noted that the different figures are not necessarily to the same scale. Moreover, the exemplary embodiments that are described below are in no way limiting. In particular, variants of the invention that comprise only a selection of features described below, separately from the other described features, may be envisaged.

In the rest of the description, an axial direction is a direction along the axis, a radial direction is a direction passing through the axis and extending in a plane transverse to the axis, and a circumferential direction is a direction extending about the axis in a plane transverse to the axis.

The rotary electric machine shown in FIG. 1 is a reversibly operating alternator for a motor vehicle. Such an alternator is referred to as a starter-alternator and comprises a rotary shaft 1, a rotor 2 which rotates conjointly with the shaft 1, a fixed polyphase stator 3 which surrounds the rotor 2, and tracking means 4 for tracking the position of the rotor 2. The axis of the shaft 1 defines the axis of rotation X-X′ of the electric machine, which is of the polyphase type here. The rotor 2 is secured to the shaft 1 and forms a rotor assembly therewith.

The rotor 2 is a claw-pole rotor, which comprises two polar claw wheels 21 and an excitation winding 22 disposed between the polar wheels 21. Each wheel 21 has a flange extending substantially perpendicularly to the shaft 1 and bearing on its external periphery axially oriented teeth directed towards the flange of the other polar wheel. The teeth are circumferentially offset from one polar wheel to the other and overlap. They each have a trapezoidal shape. The flanges are each pierced with a central bore that receives the shaft 1, and rotate conjointly with this shaft via knurlings of the shaft that are forcibly sheathed in the central bore in the flanges of the wheels 21. A core is interposed between the flanges of the polar wheels for bearing the winding 22.

When the inductor winding 22 is electrically powered, the teeth of one of the polar wheels 21 define the North poles, whereas the teeth of the other polar wheel 21 define the South poles.

The stator 3 is intended to be fixed to a fixed part of the vehicle. For its part, this stator 3 comprises both front and rear bearings 31 and 32, which are closed together and fixed to one another here with tie rods so as to form a casing, and a stator assembly 34 comprising a stator body and bearing a set of stator windings.

The stator body of the stator assembly is secured to the fixed casing 31, 32 of the stator and is borne internally thereby. As is known, the stator assembly 34 surrounds the rotor 2 and has a body in the form of a stack of laminations in which are formed a series of slots containing windings at the rate of at least one winding per phase of the starter-alternator, which here is of the three-phase type, as a variant of the six-phase type. The windings may be of the separated-coil type, interleaved-coil type or of the bar type, for example in a U shape.

The bearings 31 and 32 of hollow shape are apertured for air to circulate inside the machine of the compact type and having internal ventilation, the rotor 2 bearing here a front fan 23 and rear fan 24, each of which is at one of its axial ends. The rotor assembly 20 comprises the rotor 2 described above and the fans 23 and 24.

The fans 23, 24 have an annular shape and each have a flange 230, 240 fixed to the polar wheel in question of the rotor, for example via weld points, as a variant by crimping or screwing. Each fan thus rotates conjointly with the central shaft via the rotor. The flange 240 is provided on its external periphery with blades (not referenced).

Each bearing 31, 32, made of aluminium here, of the fixed casing of the stator 3 centrally bears a ball bearing 35, 36. In this way, the casing of the stator 3, having the bearings 31, 32 here, centrally bears at least one ball bearing in order to mount the shaft 1 of the rotor 2 in a rotatable manner. These rolling bearings 35, 36 support the front end and the rear end, respectively, of the shaft 1 and here have a single row of balls fitted between a rotary internal race and a fixed external race.

The shaft 1 continues beyond the front bearing 31, for the purpose of bearing a movement transmission member in the form of a pulley fixed to the shaft 1 on the outside of said bearing. This pulley, which rotates conjointly with the shaft 1, is intended to cooperate with a V-grooved belt (not shown), via which the combustion engine of the motor vehicle drives the shaft 1 and the assembly of the rotor 2 when the electric machine operates in generator mode. This pulley and the belt associated with it allow the electric machine to drive the combustion engine of the vehicle also in the reverse direction, when said machine operates in starter mode. The movement transmission means between the shaft 1 and the combustion engine of the vehicle as a variant may have gears, at least one variable-separation pulley chain and/or at least one belt. In this way, the movement transmission member may have multiple configurations and consist of a gear, of a toothed wheel, of a pulley, etc. The ends of the winding 22 of the rotor 2 are each connected by a wired link to slip rings 11 borne by the rear end of the shaft 1 on the outside of the casing.

A collector bears the slip rings 11. This collector is forcibly sheathed on the rear end of the shaft 1 and has a body that bears the rings 11 and an annulus (not referenced) for linkage with the ends of the excitation winding 22.

The windings of the stator assembly 34 are for their part connected via a cable link and connectors to a power stage of an electronic management and control device, advantageously borne by the rear bearing of the starter-alternator.

As can be better seen in FIG. 2, the tracking means 4 have an annular target 41 surrounding the shaft 1 and rotating conjointly with this shaft 1, and at least one fixed detection means 42 disposed close to the target 41 and cooperating therewith so as to read the target. The target is at least partially magnetic, advantageously formed by an annulus containing at least one permanent magnet. The detection means is typically formed by three Hall effect sensors, a single one of which can be seen in FIG. 2. The sensors 42 are mounted fixedly on the rear bearing 32, on the inside of this bearing 32. These sensors are mounted on a sensor holder.

Under the effect of the rotation of the target 41 conjointly with the shaft 1, the magnetic field received by each sensor 42 varies. These sensors 42 are connected to the electronic management and control device, and transmit to it signals that are a function of the magnetic fields received, this device processing said signals in order to deduce therefrom the angular position of the rotor 2.

The electronic management and control device comprises a power stage provided with an inverter, for example with MOSFET-type transistors, forming a converter that transforms the alternating current produced by the stator 3 into direct current, control means receiving the information from the sensors 42, and means for regulating the excitation current of the winding of the rotor 2. These regulating means are electrically connected to a brush-holder device, not shown, comprising brushes that are in contact with the rings 11 borne by the shaft 1.

The target is borne by a target holder 50. The target holder is in the form of a cup attached to the central shaft. The target holder may be made in one piece, for example by stamping a metal sheet. This target holder 22, of annular shape, is preferably made of a non-magnetic material. The target holder is advantageously made of steel. As a variant, the target holder is made of preferably fibre-reinforced, mouldable plastics material.

The target holder configured as a radial annulus which coaxially surrounds the central shaft is delimited for the one part on the inside by an inner bore 51 extending substantially in the direction of the axis X and for the other part on the outside by an axially oriented annular lip 52 substantially in the direction of the axis X, as is shown in FIG. 2. The target holder has a base 53 connecting the inner bore 51 and the annular lip 52. The annular target holder is coupled by fixation at its internal periphery to the internal race 361 and extends radially with respect to the axis beyond the external race.

The annular lip of the target holder 50 thus forms a cylindrical support face, turned radially inwards, of the target 41. In this way, when the target holder 50 is mounted, the target 41 extends radially around the external race of the rear ball bearing 36 and in a manner facing the sensor 42, radially interposed between the ball bearing and the target. A calibrated air gap separates the target from the sensor. The annular target is thus centred on the shaft and extends substantially around the rear rolling bearing, inside the rear bearing.

The target holder is mounted so as to be able to rotate conjointly with the central shaft axially behind the rotor. According to one embodiment of the invention, the inner bore 51 in the target holder 50 is mounted tightly on a portion associated with the central shaft 1 so as to prevent the rotation of the target holder 50 in relation to the central shaft. This tight mounting also axially immobilizes the target holder with respect to the central shaft under normal use conditions. Such a mounting allows the target holder to be precisely centred on the central shaft while still allowing easy mounting. The position of the target 41 with respect to the sensors 42 is thus particularly precise. The target holder 50 is for example forcibly mounted on the central shaft 1 by cold shrink fitting, or else by hot shrink fitting.

The base also has two diametrically opposite windows, which are intended to align the magnetic poles of the rotor with the magnetic poles of the target.

The target 41 is made from an elastomagnet. This elastomagnet has an elastomeric body containing particles of magnetic material, such as ultimately magnetized iron oxide particles. In the course of its production process, the elastomagnet target undergoes a vulcanization step. This step is advantageously carried out once the target has been positioned around the annular lip of the target holder. The elastomer vulcanization process is well known. This involves crosslinking the elastomer, for example by heating, in the presence of sulfur. In the case of the elastomagnet, the particles of magnetic elements are trapped homogeneously in the elastomer vulcanized in this way. The vulcanization creates an adhesion force between the target and the support face on which the target is positioned during the vulcanization operation. In this way, the target is fixed to the target holder by vulcanization. More specifically, the target is made according to a process having the following steps. During a preliminary step of producing the target in the form of an annulus, a mixture of elastomeric material and of particles of magnetic material, such as iron oxide particles or ferrite, is heated so as to obtain an annular target made of non-crosslinked elastomeric material. For example, a cylinder having an internal diameter equal to the external diameter of the annular lip of the target holder is produced. Then, a segment of this cylinder is cut out so as to obtain the adequately dimensioned annular target. Then, the target formed in this way is positioned around the annular lip in contact with the annular lip. Then, during a vulcanization step, the target thus formed and then positioned on the annular lip is vulcanized. The target is ultimately magnetized in order to form a plurality of North and South poles. Ferrites and/or rare earths may also be used as magnetic particles. Advantageously, during a preparation step prior to the vulcanization step, the inner face of the annular lip is coated with an adhesion primer so as to increase the adhesion force between the target 41 and the annular lip. As a variant, the target is made of a plastomagnet: a plastic annulus containing magnetic particles.

The rolling bearing device 5 forms an annular assembly comprising the rolling bearing 36, the target holder 50 and the target 51.

The rear fan 24 is interposed axially between the rolling bearing device 5 and the rotor 1 by being fixed to the rotor 2 as described above. The flange is provided with an axially oriented annular lip 241 extending along its internal periphery. The target holder extends radially beyond the annular lip of the flange, in such a way that a part of the base of the target holder is axially above the flange of the fan.

The base of the target holder has an axial offset between its internal periphery and its external periphery, in such a way that it is assembled on the rolling bearing via its inner bore 51 at its internal periphery, whereas its external periphery is axially close to the fan (at a minimum axial distance of 0.5 mm).

The base extends between its internal periphery and its external periphery in generally transversely oriented parts connected via inclined parts, in such a way that the section of the cup in a plane containing the axis has descending staircase steps when moving radially from the axis of the machine towards the outside.

The base of the cup comprises radially extending tabs. The tabs are advantageously evenly spaced apart. There are four tabs, for example. As a variant, the base comprises eight evenly spaced-apart tabs.

FIG. 3 illustrates the cup in a first embodiment. Two strips of material oriented substantially radially and substantially parallel to one another are removed in the base of the cup, forming an opening 531 through which extends the remaining strip of material that is attached to the rest of the base of the target holder via its radial ends. The remaining strip is stamped so as to form a tab 532 protruding axially with respect to the rest of the base. The tab is thus in one piece with the rest of the target holder. The tab therefore extends radially to the base of the cup.

The maximum circumferential extension is defined as the angular extension about the axis X as close as possible to the edge of the base. Advantageously, the ratio between the maximum circumferential extension ϕ1 of the tab and the maximum circumferential extension ϕ2 of the opening, which are illustrated in FIG. 3, is between 0.05 and 0.33, and advantageously between 0.1 and 0.25.

In a second embodiment illustrated in FIG. 4, the tab 532 is fixed to the rest of the base of the target holder only via one of its radial ends, the other end being free.

As a variant of any one of the preceding embodiments, the tab is formed by two cutouts which are substantially radial and substantially parallel to one another without removal of material, then by stamping the strip of material defined by the cutouts.

As a variant of any one of the preceding embodiments, such tabs are obtained directly during the stamping of the cup.

As a variant of any one of the preceding embodiments, the removed strips of material are such that the opening through which the tab extends flares out between the inner periphery of the cup and the outer periphery.

Before being mounted in the machine, in section at a tab, as illustrated in FIG. 3b, the base of the cup extends on either side of the axial end 533 of the tab substantially in the direction of the axis X, in transversely oriented parts and inclined parts. The distance between the axial end of the tab 533 and the axial end of the base at the axially oriented annular lip 52 of the cup is advantageously h between 0.006 and 0.01% of the axial distance between the target holder and the rotor. The radial position of the axial end of the tab 533 is such that, when the cup and the fan are coaxial, the axial end of the tab axially faces the axially oriented annular lip 241 of the fan.

During the mounting, the axial end of the tab 533 bears against the annular lip of the fan and deforms, as illustrated in FIG. 2. The section of the cup in a plane containing the axis has descending staircase steps when moving radially from the axis of the machine towards the outside. The flange of the fan is at an axial distance from the base of the cup. This elastic deformation of the tab holds the target holder in a flexible manner, which limits its deformation when the machine is being used. In addition, the mounting of the machine is simplified, because it is not necessary to bring the cup base to bear against the fan. This avoids placing the cup under stress, entailing the risk of breaking it and of subsequently altering the quality of the measurement of the position signal.

As a variant, the radial position of the axial end of the tab 533 is such that, when the cup and the fan are coaxial, the axial end of the tab axially faces the flange of the fan. With mounting, a part of the tab therefore bears against the flange of the fan under stress.

The case in which the tabs are disposed axially above the fan when the fan and the target holder are coaxial was described above. As a variant, in the case in which the diameter of the inner periphery of the fan is larger or when the fan is absent, the tabs will face the axial end of the rotor. In this case, with mounting, at least one part of a tab bears against the axial end of the rotor under stress.

1. Rolling bearing device that is able to be mounted around a shaft of a rotary electric machine of axis X, and axially above a rotor assembly,
the rolling bearing device comprising:
a rolling bearing comprising an inner race and an outer race that are centred on the axis;
a target holder which is fixed to the inner race and extends radially with respect to the axis beyond the outer race, in a base extended by an axial lip,
a target which is secured to the target holder and is able to cooperate with a detection means for tracking the rotation of the race about the axis,
characterized in that the base of the target holder comprises at least one axially protruding tab designed to axially deform when the base bears against the rotor assembly once the rolling bearing has been mounted on the shaft.

2. Device according to claim 1, wherein the tab extends radially.

3. Device according to claim 1, wherein the base comprises at least one opening through which the tab extends between two ends.

4. Device according to claim 3, wherein the ratio between a maximum circumferential extension of the opening (ϕ1) and a maximum circumferential extension of the tab (ϕ2) is between 3 and 20.

5. Device according to claim 1, wherein the tab is fixed via its two ends to the rest of the base of the target holder.

6. Device according to claim 1, wherein the tab is fixed at one end to the base of the target holder, the other end being free.

7. Device according to claim 1, wherein the tab is obtained by stamping.

8. Device according to claim 1, comprising at least four tabs evenly distributed about the axis X of the machine.

9. Rotary electric machine comprising:
a rotary shaft, a rotor assembly which rotates conjointly with the shaft, a stator surrounding the rotor, and a rolling bearing device according to claim 1, wherein the at least one tab of the base of the target holder is mounted under stress against the rotor assembly.

10. Rotary electric machine according to claim 9, wherein the rotor assembly comprises a fan, the at least one tab of the base of the target holder being mounted under stress against the fan.

11. Device according to claim 2, wherein the base comprises at least one opening through which the tab extends between two ends.

12. Device according to claim 2, wherein the tab is fixed via its two ends to the rest of the base of the target holder.

13. Device according to claim 2, wherein the tab is fixed at one end to the base of the target holder, the other end being free.

14. Device according to claim 2, wherein the tab is obtained by stamping.

15. Device according to claim 2, comprising at least four tabs evenly distributed about the axis X of the machine.

16. Rotary electric machine comprising:
a rotary shaft, a rotor assembly which rotates conjointly with the shaft, a stator surrounding the rotor, and a rolling bearing device according to claim 2, wherein the at least one tab of the base of the target holder is mounted under stress against the rotor assembly.

17. Device according to claim 3, wherein the tab is fixed via its two ends to the rest of the base of the target holder.

18. Device according to claim 3, wherein the tab is fixed at one end to the base of the target holder, the other end being free.

19. Device according to claim 3, wherein the tab is obtained by stamping.

20. Device according to claim 3, comprising at least four tabs evenly distributed about the axis X of the machine.
